(19) United States
(12) Patent Application Publication
(10) Pub. No.: US 2010/0182333 A1
(43) Pub. Date: Jul. 22, 2010

(54) Color Deviation Compensating Method and Driving Device for an LCD Panel and Related LCD Device

(76) Inventor: Shao-Yang Chiang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/536,490

(22) Filed: Aug. 6, 2009

Related U.S. Application Data
(60) Provisional application No. 61/146,641, filed on Jan. 22, 2009.

(30) Foreign Application Priority Data
May 8, 2009 (TW) 098115268

(51) Int. Cl. G09G 3/36; G09G 5/02; G09G 5/10

(52) U.S. Cl. 345/589; 345/690; 345/88

(57) ABSTRACT

A color deviation compensating method for a LCD panel is disclosed. The LCD panel includes a plurality of pixel units arranged as a matrix, and each of the pixel units includes a plurality of sub-pixel units corresponding to a plurality of colors. The color deviation compensating method includes dividing the plurality of pixel units into a plurality of groups by columns, wherein each group is corresponding to a column of the LCD panel, and driving pixel units of the groups according to a plurality of triggering orders, wherein each of the triggering orders is corresponding to a charging sequence of sub-pixel units of pixel units corresponding to a group when displaying an image.

### CROSS REFERENCE TO RELATED APPLICATIONS

This application claims the benefit of U.S. Provisional Application No. 61/146,641, filed on Jan. 22, 2009 and entitled “LCD Panel Capable of Spatially Compensating Color Shift ”, the contents of which are incorporated herein by reference.

### BACKGROUND OF THE INVENTION

1. Field of the Invention

The present invention is related to a color deviation compensating method and driving device for an LCD panel and related LCD device, and more particularly, to a color deviation compensating method, driving device and related LCD device capable of preventing color deviation.

2. Description of the Prior Art

A liquid crystal display (LCD) has advantages of light weight, low power consumption, low radiation contamination, etc., and is widely used in various information products, such as computer systems, cell phones, personal digital assistants (PDAs), etc. In an LCD monitor, incident light produces different polarization or refraction effects when the alignment of liquid crystal molecules is altered. Thus, thin film transistors (TFTs) are utilized for controlling the alignment of the liquid crystal molecules, to control the light transmittance, and produce light with different colors and intensities.

TFTs can be classified into two categories according to a low temperature polysilicon (LTPS) technology and an amorphous-silicon technology, which are well-known in the art and not further narrated. Comparing to an amorphous-silicon TFT LCD, an LTPS TFT LCD has shorter response time, as well as advantages of high brightness, high resolution, low power consumption, etc. Thus, the LTPS TFT LCD has been applied in more and more applications.

Since the LTPS TFT LCD has high electron transfer rate, the liquid crystal molecules can be charged in a short period. Therefore, in the LTPS TFT LCD, an identical source driving signal can be corresponding to multiple channels. In such a situation, the related driving circuit should include multiplexing devices. Please refer to FIG. 1, which is a schematic diagram of a portion of a driving circuit in a prior art LTPS TFT LCD 10. For the sake of clearness, FIG. 1 merely illustrates pixel units PX1, PX2, PX3, PX4, a gate driving circuit 100, a source driving circuit 102, a multiplexing device 104 and a multiplexing control unit 106 of the LTPS TFT LCD 10. Each of the pixel units PX1, PX2, PX3, PX4 is composed of a red sub-pixel unit R, a green sub-pixel unit G and a blue sub-pixel unit B, which are driven by different TFTs for controlling gray levels of red, green and blue. The gate driving circuit 100 is utilized for outputting a gate driving signal GT, to timely trigger TFTs of each pixel unit. The source driving circuit 102 is utilized for outputting source driving signals S1-S4, to control the gray levels generated by each pixel unit. The multiplexing device 104 includes switching units SW1-SW12 to transfer the source driving signals S1-S4 according to control signals MUX1, MUX2, MUX3 outputted by the multiplexing control unit 106. For example, if the control signal MUX1 is pulsed “ON”, the switching units SW1, SW4, SW7, SW10 transfer the source driving signals S1-S4 to red sub-pixel units R of the pixel units PX1, PX2, PX3, PX4, to charge the liquid crystal molecules (equivalent to capacitors), so as to display the corresponding red gray level. Therefore, as long as the multiplexing control unit 106 sequentially outputs the control signals MUX1, MUX2 and MUX3, the pixel units can display red, green and blue components, so as to show the complete image content.

However, in practice, even if voltage levels of the source driving signals S1-S4 are identical, since the LTPS TFT LCD 10 inevitably includes defects, voltages of the sub-pixel units R, G, B after charged may differ by different charging sequences. For example, if the LTPS TFT LCD 10 is normally-white, and the control signal MUX1 is first turned on, then the red sub-pixel units R are not fully charged, causing blue deviation of the pixel units PX1, PX2, PX3, PX4. If the control signal MUX3 is first turned ON, the blue sub-pixel units B are not fully charged, causing red deviation of the pixel units PX1, PX2, PX3, PX4.

Therefore, enhancing the driving method of the LTPS TFT LCD to prevent color deviation has been a major focus of the industry.

### SUMMARY OF THE INVENTION

It is therefore a primary objective of the claimed invention to provide a color deviation compensating method and driving device for an LCD panel and related LCD device.

The present invention discloses a color deviation compensating method for a liquid crystal display (LCD) panel. The LCD panel comprises a plurality of pixel units arranged as a matrix, each of the pixel units comprising a plurality of sub-pixel units corresponding to a plurality of colors. The color deviation compensating method comprises dividing the plurality of pixel units into a plurality of groups by columns, each group corresponding to at least one column of the LCD panel, and driving pixel units of the plurality of groups according to a plurality of triggering orders, each of the triggering orders corresponding to a charging sequence of sub-pixel units of pixel units corresponding to a group when displaying an image.

The present invention further discloses a driving device for a liquid crystal display (LCD) panel. The LCD panel comprises a plurality of pixel units arranged as a matrix, each of the pixel units comprising a plurality of sub-pixel units corresponding to a plurality of colors. The driving device comprises a gate driving circuit for generating a plurality of gate driving signals corresponding to a plurality of rows of the LCD panel for the plurality of pixel units, a source driving circuit for generating a plurality of source driving signals corresponding to a plurality of columns of the LCD panel, and a multiplexing module coupled between the source driving circuit and the plurality of pixel units for outputting the plurality of source driving signals to the plurality of pixel units according to the plurality of triggering orders, each of the triggering orders corresponding to a charging sequence of sub-pixel units of pixel units corresponding to at least one column of the plurality of columns when displaying an image.

The present invention further discloses a liquid crystal display (LCD) device. The LCD device comprises an LCD panel comprising a plurality of pixel units arranged as a matrix, each pixel unit comprising a plurality of sub-pixel units corresponding to a plurality of colors, and a driving device comprising a gate driving circuit for generating a plurality of gate driving signals corresponding to a plurality of rows of the LCD panel for the plurality of pixel units, a source driving circuit, for generating a plurality of source driving signals corresponding to a plurality of columns of the LCD panel, and a multiplexing module coupled between the source driving circuit and the plurality of pixel units for outputting the plurality of source driving signals to the plurality of pixel units according to the plurality of triggering orders, each of the triggering orders corresponding to a charging sequence of sub-pixel units of pixel units corresponding to at least one column of the plurality of columns when displaying an image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of aportion of a driving circuit of a prior art LTPS TFT LCD.

FIG. 2 is a schematic diagram of an LCD device according to an embodiment of the present invention.

FIG. 3, FIG. 4 and FIG. 5 are schematic diagrams of alternative embodiments of a multiplexing module shown in FIG. 2.

FIG. 6 is a schematic diagram of a color deviation compensating process according to an embodiment of the present invention.

### DETAILED DESCRIPTION

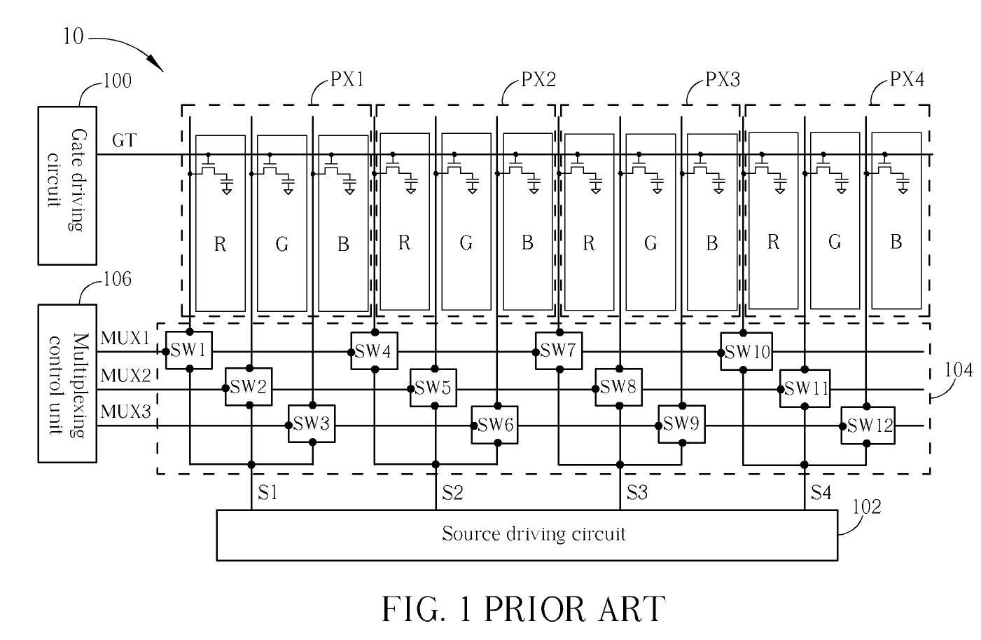

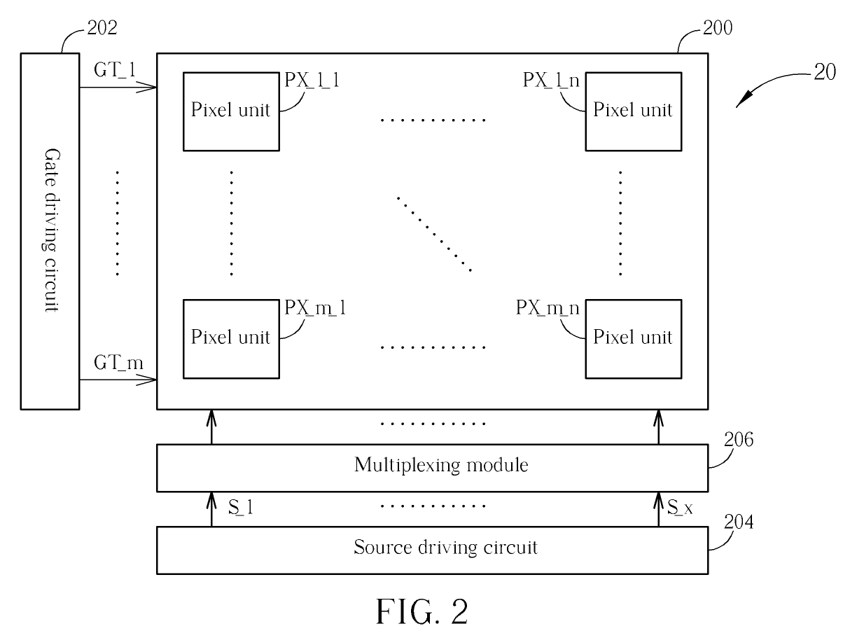

Please refer to FIG. 2, which is a schematic diagram of a liquid crystal display (LCD) device 20 according to an embodiment of the present invention. The LCD device 20 includes an LCD panel 200, a gate driving circuit 202, a source driving circuit 204 and a multiplexing module 206. The LCD panel 200 is preferably a low temperature polysilicon (LTPS) LCD panel, and includes a plurality of pixel units PX_1_1-PX_m_n arranged as a matrix. That is, each pixel unit is regarded as an element of an m×n matrix, and composed of a red sub-pixel unit, a green sub-pixel unit and a blue sub-pixel unit, like the pixel units PX1, PX2, PX3 and PX4 shown in FIG. 1. The gate driving circuit 202, the source driving circuit 204 and the multiplexing module 206 form a driving device of the LCD panel 200, to drive the LCD panel 200 to display images. The gate driving circuit 202 is utilized for generating gate driving signals GT_1-GT_m to the pixel units PX_1_1-PX_m_n, and the gate driving signals GT_1-GT_m are corresponding to the rows of the LCD panel 200. The source driving circuit 204 is utilized for generating source driving signals S_1-S_x to the multiplexing module 206, so as to output the source driving signals S_1-S_x to the pixel units PX_1_1-PX_m_n based on different triggering orders. Each triggering order is corresponding to a charging sequence of sub-pixel units of pixel units corresponding to at least one column of the LCD panel 200 when displaying an image.

In short, the present invention divides the pixel units PX_1_1-PX_m_n into groups by columns, such that each group corresponds to pixel units of at least one column of the LCD panel 200, and different groups have different triggering orders. The “triggering order” herein is related to a turning-on (charging) sequence of sub-pixel units of a pixel unit when displaying image, such as “red→green→blue”, “blue→green→red”, etc. Also, the triggering order is related to not only difference of “orders” but also difference of “timing sequences”. That is, when display an image, the pixel units PX_1_1-PX_m_n charge corresponding sub-pixel units according to different orders or sequences. Therefore, in an arbitrary row of the LCD panel 200, sub-pixel units corresponding to different colors are simultaneously triggered. For example, if a triggering order of one group is “red→green→blue”, and a triggering order of another group is “blue→green→red”, then red sub-pixel units of the former group and blue sub-pixel units of the latter group are triggered at the same time. In such a situation, via the averaging tendency of human eyes, color deviation can be compensated.

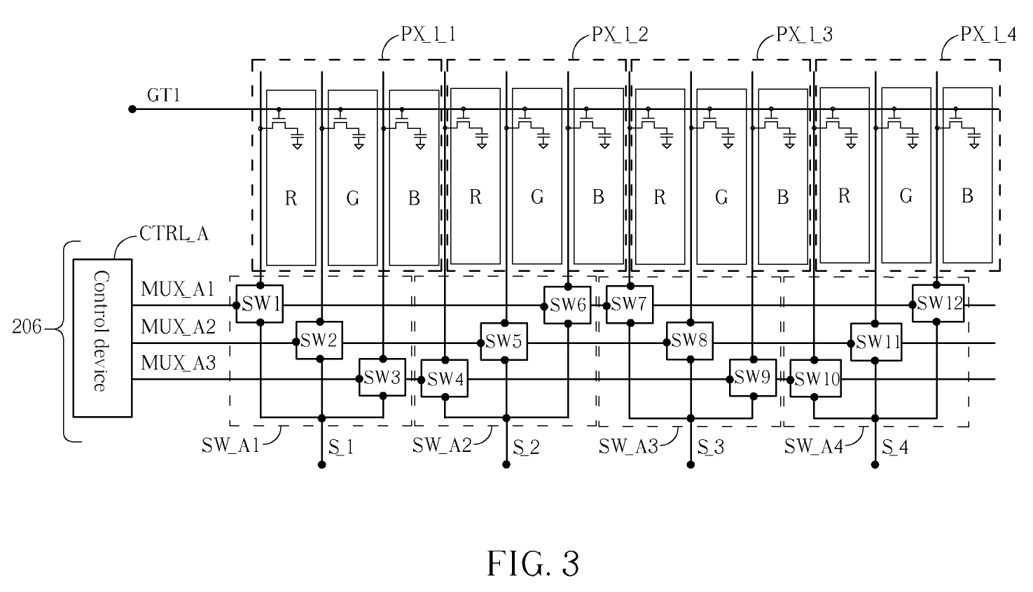

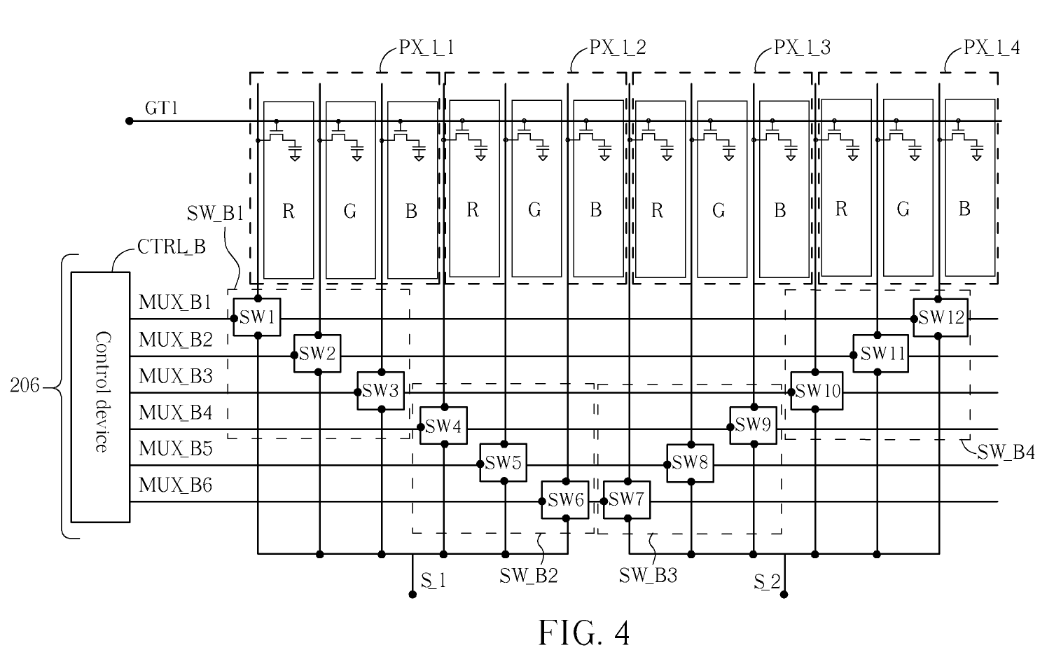

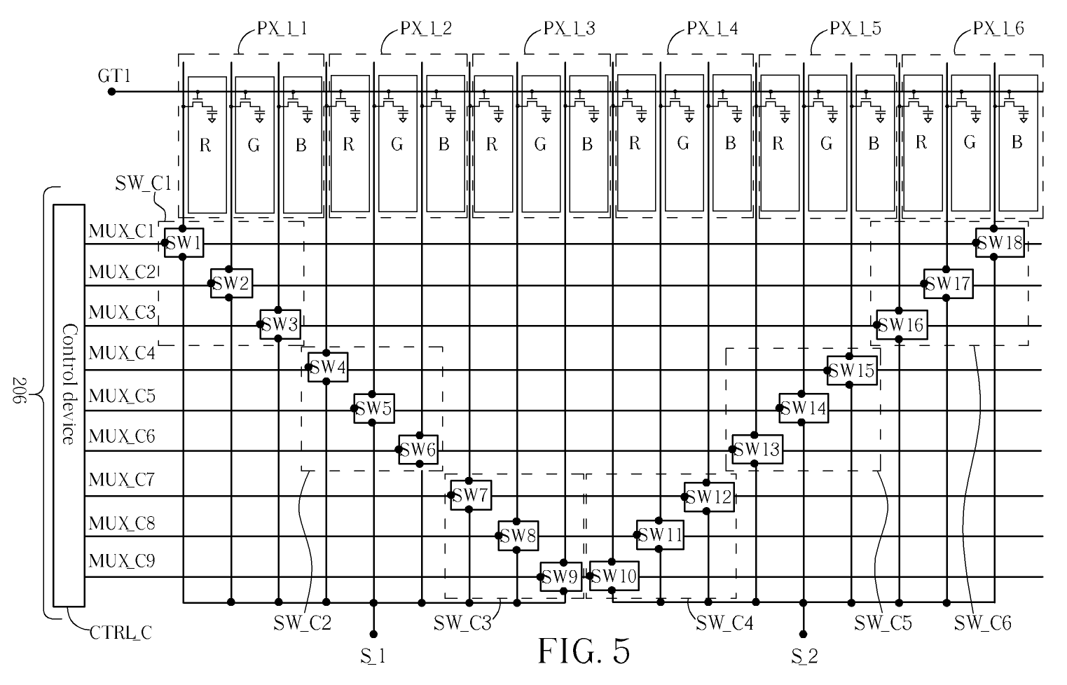

Note that, the “triggering order” of the present invention means the charging sequence of the sub-pixel units, and can be implemented by the multiplexing module 206, illustrated by the following three embodiments. Please refer from FIG. 3 to FIG. 5, which are schematic diagrams of alternative embodiments of the multiplexing module 206. For the sake of clearness, partial components of the LCD device 20 are omitted from FIG. 3 to FIG. 5. Refer to FIG. 2 for the entire architecture of the LCD panel 20. First, in FIG. 3, the multiplexing module 206 controls the triggering orders of the pixel units PX_1_1-PX_1_4 via a control device CTRL_A and switching modules SW_A1-SW_A4. The switching modules SW_A1-SW_A4 are composed of switching units SW1-SW12. Each switching unit is controlled by the control device CTRL_A, to transfer the source driving signals S_1-S_4 to the corresponding sub-pixel units according to control signals MUX_A1, MUX_A2, MUX_A3 outputted from the control device CTRL_A. As illustrated in FIG. 3, the pixel units PX_1_1-PX_1_4 are divided into two groups: one group includes the pixel units PX_1_1, PX_1_3 and is corresponding to the triggering order “red→green→blue”; the other group includes the pixel units PX_1_2, PX_1_4 and is corresponding to the triggering order “blue→green→red”. Thus, when the control device CTRL_A sequentially outputs the control signals MUX_A1, MUX_A2 and MUX_A3, these two groups charge the corresponding sub-pixels units by different charging orders. For example, when the control signal MUX_A1 is pulsed “ON”, the switching units SW1, SW7 transfer the source driving signals S_1, S_3 to the red sub-pixels R of the pixel units PX_1_1, PX_1_3; meanwhile, the switching units SW6, SW12 transfer the source driving signals S_2, S_4 to the blue sub-pixel units B of the pixel units PX_1_2, PX_1_4. As a result, the pixel units in the same row charge the corresponding sub-pixel units R, G, B by different orders, so as to compensate color deviation via the averaging tendency of human eyes.

In FIG. 3, the control device CTRL_A simultaneously controls the switching modules SW_A1-SW_A4, and is equivalent to four control units corresponding to the switching modules SW_A1-SW_A4. In this embodiment, the four control units are integrated into the control device CTRL_A capable of sequentially outputting the control signals MUX_A1, MUX_A2, MUX_A3. In addition, the abovementioned two triggering orders of the pixel units PX_1_1-PX_1_4 differ in “order” and not in “timing”.

Next, in FIG. 4, the multiplexing module 206 controls the triggering orders of the pixel units PX_1_1-PX_1_4 via a control device CTRL_B and switching modules SW_B1-SW_B4. The switching modules SW_B1-SW_B4 are composed of switching units SW1-SW12, and utilized for transferring the source driving signals S_1, S_2 to the corresponding sub-pixel units according to control signals MUX_B1-MUX_B6 outputted from the control device CTRL_B. As illustrated in FIG. 4, the pixel units PX_1_1-PX_1_4 are divided into four groups. The pixel units PX_1_1, PX_1_2 have the same triggering order “red→green→blue”, but in temporal domain, the triggering order of the pixel units PX_1_2 follows that of the pixel units PX_1_1. Similarly, the pixel units PX_1_3, PX_1_4 have the same triggering order “blue→green→red”, while the trigger order of the pixel units PX_1_4 follows that of the pixel units PX_1_3. Therefore, when the control device CTRL_B sequentially outputs the control signals MUX_B1-MUX_B6, the sub-pixel units of the pixel units PX_1_1-PX_1_4 are charged by to different orders and timing sequences. For example, when the control signal MUX_B1 is pulsed “ON”, the switching units SW1, SW12 respectively transfer the source driving signals S_1, S_2 to the red sub-pixel unit R of the pixel unit PX_1_1 and the blue sub-pixel unit B of the pixel unit PX_1_4. As a result, the pixel units in the same row charge the corresponding sub-pixel units R, G, B by different orders and timing sequence, so as to compensate color deviation via the averaging tendency of human eyes.

As illustrated in FIG. 4, the “triggering order” of the present invention represents differences of orders and timing sequences. That is, although the pixel units PX_1_1, PX_1_2 have the same triggering order “red→green→blue”, yet sequentially, the pixel units PX_1_2 follows the pixel units PX_1_1. In addition, similar to the control device CTRL_A of FIG. 3, the control device CTRL_B is equivalent to four control units respectively corresponding to the switching modules SW_B1-SW_B4.

Finally, in FIG. 5, the multiplexing module 206 controls triggering orders of pixel units PX_1_1-PX_1_6 via a control device CTRL_C and switching modules SW_C1-SW_C6. The switching modules SW_C1-SW_C6 are composed of switching units SW1-SW18 and utilized for transferring the source driving signals S_1, S_2 to corresponding sub-pixel units according to control signals MUX_C1-MUX_C9 outputted by the control device CTRL_C. As illustrated in FIG. 5, the pixel units are divided into six groups. The pixel units PX_1_1, PX_1_2, PX_1_3 have the same triggering order “red→green→blue”, while the triggering order of the pixel units PX_1_3 follows the triggering order of the pixel units PX_1_2, and the triggering order of the pixel units PX_1_2 follows the triggering order of the pixel units PX_1_1. Similarly, the pixel units PX_1_4, PX_1_5, PX_1_6 have the same triggering order “blue→green→red”, while the triggering order of the pixel units PX_1_6 follows the triggering order of the pixel units PX_1_5, and the triggering order of the pixel units PX_1_5 follows the triggering order of the pixel units PX_1_4. As a result, when the control device CTRL_C sequentially outputs the control signals MUX_C1-MUX_C9, the sub-pixel units of the pixel units PX_1_1-PX_1_6 are charged by different orders and sequences. For example, when the control signal MUX_C1 is pulsed “ON”, the switching units SW1, SW8 respectively transfer the source driving signal S_1, S_2 to the red sub-pixel unit R of the pixel unit PX_1_1 and the blue sub-pixel unit B of the pixel unit PX_1_6. As a result, the pixel units in the same row charge the corresponding sub-pixel units R, G, B by different orders and timing sequence, so as to compensate color deviation via the averaging tendency of human eyes.

As illustrated in FIG. 5, the “triggering orders” of the pixel units PX_1_1-PX_1_6 represent differences of orders and timing sequences. In addition, similar to the control device CTRL_A of FIG. 3, the control device CTRL_C is equivalent to six control units respectively corresponding to the switching modules SW_C1-SW_C6.

Therefore, when displaying an image, the present invention charges the sub-pixel units of pixel units in the same row by different orders or timing sequences. As a result, in a row of the LCD panel 20, sub-pixel units corresponding to different colors are triggered at the same time, so as to compensate color deviation via the averaging tendency of human eyes.

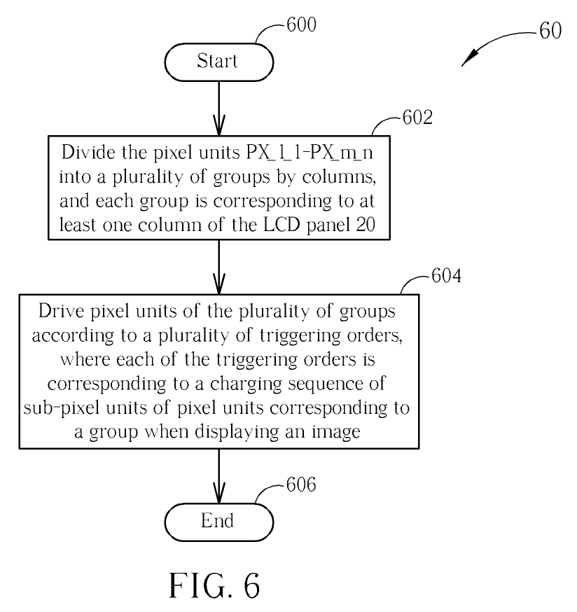

Furthermore, operations of the LCD panel 20 can be summarized into a color deviation compensating process 60, as illustrated in FIG. 6. The color deviation compensating process 60 comprises the following steps:

Step 600: Start.

Step 602: Divide the pixel units PX_1_1-PX_m_n into a plurality of groups by columns, and each group is corresponding to at least one column of the LCD panel 20.

Step 604: Drive pixel units of the plurality of groups according to a plurality of triggering orders, where each of the triggering orders is corresponding to a charging sequence of sub-pixel units of pixel units corresponding to a group when displaying an image.

Step 606: End.

Detailed description of the color deviation compensating process 60 can be referred in the above, and is not further narrated herein.

In the prior art, due to defects of the LTPS TFT LCD, the charged voltage levels of the sub-pixel units corresponding to different colors differ by different charging sequences, leading to the color deviation phenomenon. In comparison, in the present invention, the sub-pixel units of different pixel units in the same row are charged by different orders or timing sequences, so as to compensate color deviation via the averaging tendency of human eyes.

To sum up, the present invention charges the sub-pixel units of different pixel units in the same row by different orders or timing sequences, so as to compensate color deviation via the averaging tendency of human eyes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color deviation compensating method for a liquid crystal display (LCD) panel, the LCD panel comprising a plurality of pixel units arranged as a matrix, each of the pixel units comprising a plurality of sub-pixel units corresponding to a plurality of colors, the color deviation compensating method comprising:
dividing the plurality of pixel units into a plurality of groups by columns, each group corresponding to at least one column of the LCD panel; and
driving pixel units of the plurality of groups according to a plurality of triggering orders, each of the triggering orders corresponding to a charging sequence of sub-pixel units of pixel units corresponding to a group when displaying an image.

2. The color deviation compensating method of claim 1, wherein the plurality of colors are red, green and blue.

3. The color deviation compensating method of claim 1, wherein the plurality of triggering orders are different.

4. The color deviation compensating method of claim 1, wherein the LCD panel is a low temperature polysilicon thin film transistor LCD panel.

5. A driving device for a liquid crystal display (LCD) panel, the LCD panel comprising a plurality of pixel units arranged as a matrix, each of the pixel units comprising a plurality of sub-pixel units corresponding to a plurality of colors, the driving device comprising:
a gate driving circuit, for generating a plurality of gate driving signals corresponding to a plurality of rows of the LCD panel for the plurality of pixel units;
a source driving circuit, for generating a plurality of source driving signals corresponding to a plurality of columns of the LCD panel; and
a multiplexing module, coupled between the source driving circuit and the plurality of pixel units, for outputting the plurality of source driving signals to the plurality of pixel units according to the plurality of triggering orders, each of the triggering orders corresponding to a charging sequence of sub-pixel units of pixel units corresponding to at least one column of the plurality of columns when displaying an image.

6. The driving device of claim 5, wherein the plurality of colors are red, green and blue.

7. The driving device of claim 5, wherein the plurality of triggering orders are different.

8. The driving device of claim 5, wherein the multiplexing module comprises a plurality of switching modules, and each switching module comprises:
a plurality of switching units, coupled between one of the plurality of source driving signals and a plurality of sub-pixel units of a column of the LCD panel, for outputting the source driving signal to the plurality of sub-pixel units according to a plurality of control signals; and
a control unit, for generating the plurality of control signals to the plurality of switching units according to one of the plurality of triggering orders, to make the plurality of switching units to output the source driving signal to the plurality of sub-pixel units according to the triggering order.

9. The driving device of claim 5, wherein the LCD panel is a low temperature polysilicon thin film transistor LCD panel.

10. A liquid crystal display (LCD) device comprising:
an LCD panel, comprising a plurality of pixel units arranged as a matrix, each pixel unit comprising a plurality of sub-pixel units corresponding to a plurality of colors; and
a driving device, comprising:
a gate driving circuit, for generating a plurality of gate driving signals corresponding to a plurality of rows of the LCD panel for the plurality of pixel units;
a source driving circuit, for generating a plurality of source driving signals corresponding to a plurality of columns of the LCD panel; and
a multiplexing module, coupled between the source driving circuit and the plurality of pixel units, for outputting the plurality of source driving signals to the plurality of pixel units according to the plurality of triggering orders, each of the triggering orders corresponding to a charging sequence of sub-pixel units of pixel units corresponding to at least one column of the plurality of columns when displaying an image.

11. The LCD device of claim 10, wherein the plurality of colors are red, green and blue.

12. The LCD device of claim 10, wherein the plurality of triggering orders are different.

13. The LCD device of claim 10, wherein the multiplexing module comprises a plurality of switching modules, and each switching module comprises:
a plurality of switching units, coupled between one of the plurality of source driving signals and a plurality of sub-pixel units of a column of the LCD panel, for outputting the source driving signal to the plurality of sub-pixel units according to a plurality of control signals; and
a control unit, for generating the plurality of control signals to the plurality of switching units according to one of the plurality of triggering orders, to make the plurality of switching units to output the source driving signal to the plurality of sub-pixel units according to the triggering order.

14. The LCD device of claim 10, wherein the LCD panel is a low temperature polysilicon thin film transistor LCD panel.
